(19) United States
(12) Patent Application Publication
(10) Pub. No.: US 2018/0338519 A1
(43) Pub. Date: Nov. 29, 2018

(54) PRINTING UNIT FOR PRINTING FOODS

(71) Applicant: BSH HAUSGERAETE GMBH, MUENCHEN (DE)

(72) Inventors: MICHAELA ALBERT, AURA (DE); TOBIAS SCHMIDT, MUENCHEN (DE)

(21) Appl. No.: 15/776,878

(22) PCT Filed: Oct. 13, 2016
(86) PCT No.: PCT/EP2016/074579

§ 371 Date: May 17, 2018

(30) Foreign Application Priority Data
Nov. 18, 2015 (DE) 10 2015 222 758.8

(51) Int. Cl. A23P 20/25; A23P 30/20; B29C 64/209

(52) U.S. Cl. CPC A23P 20/25; A23P 30/20; B33Y 30/00; A23P 2020/253; B29C 64/209

(57) ABSTRACT

A printing unit for printing a food includes a printing head, which has a printing-head body and a cartridge carrier and which can be positioned over a printing surface. The cartridge carrier holds at least one removable cartridge for edible printing mass. The cartridge has a plunger, a cartridge body, and a cartridge bottom with a cartridge nozzle. The printing-head body has a cartridge motor for pressing the plunger of a cartridge that is inserted in the cartridge carrier toward the cartridge bottom of the inserted cartridge from above in order to press printing mass onto the printing surface via the cartridge nozzle. The printing unit has a positioning device for moving the printing head to different positions. A control unit controls the positioning device and the cartridge motor in order to print a food with the printing mass from the cartridge.

The invention relates to a food printer, in particular the invention relates to a printing unit with which printing mass for a food can be extruded.

Food printers make it possible for a user to prepare a plurality of different foods individually and reliably. For example different baked goods can be produced on an individual basis and on demand by a food printer.

The production of different foods with different forms requires a food printer, which can extrude different edible print masses of a food to be produced at different points in a flexible and efficient manner. The present document deals with the technical task of providing a printing unit as well as with a built-in kitchen appliance with such characteristics.

The object is achieved in each case by the subject matter of the independent claims. Advantageous forms of embodiment are described in the dependent claims and in the subsequent description and are shown in the figures of the enclosed drawing.

In accordance with one aspect of the invention a printing unit for the printing of a food is described accordingly. The printing unit comprises a printing head with a printing-head body and with a (possibly removable) cartridge carrier. The printing-head body in this case is typically fixed firmly to the printing unit. The cartridge carrier is configured to accept at least one removable cartridge for edible printing mass. Typically a number of cartridges with different print masses can be accepted by the cartridge carrier. A cartridge in this case comprises a plunger, a cartridge body and a cartridge bottom having a cartridge nozzle.

The printing-head body has a cartridge motor, with which the plunger of a cartridge inserted into the cartridge carrier can be pushed in the direction of the cartridge bottom of the inserted cartridge, in order to push printing mass out of the inserted cartridge via the cartridge nozzle. The cartridge motor can comprise a telescopic motor with an extendable cylinder, which acts on the plunger of an inserted cartridge.

Moreover the printing unit comprises positioning means, which are configured to move the printing head to different positions or points. Furthermore the printing unit comprises a control unit, which is configured to control the positioning means and the cartridge motor, in order to print a food by means of the printing mass from at least one of the inserted cartridges. In this case the control unit can refer back to a predefined recipe, which shows the points or positions and the respective quantity of printing mass that has to be extruded for the production of a food. The positioning means and/or the cartridge motor can then be controlled as a function of the recipe, in order to print a food corresponding to the recipe.

The printing head of the printing unit described is thus configured to use different cartridges with different printing masses. This enables different foods to be printed in an efficient manner, in particular different printing masses can be introduced into the printing unit in an efficient manner. The cartridges used in such cases include all the necessary components for the extrusion of printing mass (in particular a plunger and a nozzle), so that the printing unit itself does not come into contact with the printing mass, and so that the printing unit does not have to be cleaned for the printing of different printing masses. The printing of different printing masses can be implemented in a simple manner through the exchange of cartridges.

The printing head can be positioned, using the positioning means, above a printing surface for a food to be printed. For this purpose the cartridge carrier is configured to accept a cartridge such that the plunger is arranged at the top and the nozzle at the bottom. The cartridge motor can then push the plunger of a cartridge inserted into the cartridge carrier from the top in the direction of the cartridge bottom, in order to push printing mass via the cartridge nozzle onto the printing surface. In particular in this case the extruded printing mass can fall as a result of the force of gravity onto the printing surface arranged below the cartridge nozzle, in order to print the food. In this way a food can be produced in an efficient manner (if necessary as individual points).

The plunger, the cartridge body and the cartridge bottom of a cartridge can be designed such that the plunger, the cartridge body and the cartridge bottom can be separated from one another by the user for cleaning. In this case the plunger can be formed by a cartridge lid, which closes off the cartridge on a side facing away from the cartridge bottom. The cartridge lid can thus be embodied so that the cartridge lid will be pushed directly as a plunger by a cartridge motor into the cartridge body. As an alternative the cartridge lid can have a separate plunger, which is moved by a cartridge motor. The cartridge can thus be broken down into individual parts (cartridge lid with plunger, cartridge body and cartridge bottom with cartridge nozzle), which can then be cleaned individually. After being cleaned, the individual parts can be re-assembled (e.g. put together) in order to provide a cleaned cartridge for accepting printing mass. The described division into three parts thus enables a cartridge to make simple cleaning possible.

The cartridge carrier can be configured to accept a plurality of removable cartridges. The printing-head body can comprise at least one cartridge motor for each of the plurality of cartridges. The provision of a printing head with a number of cartridges enables complex foods to be produced from a number of different printing masses. The control unit can be configured (e.g. as a function of a recipe) to control the individual cartridges, in order to control the quantity of extruded printing mass of the individual cartridges.

Furthermore the cartridge carrier can be configured to accept cartridges with different capacities for printing mass, in particular in this case space can be provided in the cartridge carrier that can be used for different sizes of cartridges. The use of cartridges with different capacities enables the flexibility in the production of foods to be increased further.

In particular the cartridge carrier can be configured to accept at least two first cartridges with a first capacity. Furthermore the cartridge carrier can be configured, at the location for the two first cartridges, to accept a second cartridge with a second capacity, which is greater than the first capacity (typically twice as great as the first capacity). Moreover the cartridge carrier can be configured, at the location for the two second cartridges (i.e. at the location for four first cartridges), to accept a third cartridge with a third capacity, which is greater than the second capacity (typically twice as great as the second capacity and four times as great as the first capacity). For example the cartridge carrier can be configured to accept at least the following combinations of cartridges: Four first cartridges, two second cartridges; two first cartridges in combination with one second cartridge; and a third cartridge. Thus, with the restricted space of a cartridge carrier, a high degree of flexibility in relation to different compositions of foods to be produced can be provided.

The printing-head body can have at least one cartridge motor for each first cartridge. On the other hand the plunger of a second cartridge can be actuated by at least two cartridge motors. The plunger of a third cartridge can be actuated by four cartridge motors. The control unit can be configured (e.g. on the basis of sensor data, which shows the type of cartridges used) to establish the type of the one or more cartridges used. The cartridge motors can then be controlled as a function of the type of the cartridges used. Through the coordinated control of a number of cartridge motors for larger cartridges it can be guaranteed that, even when relatively large cartridges are being used, printing mass can be extruded in a reliable manner.

The positioning means can comprise lifting means with a lifting motor, in order to change a height of the printing head relative to the printing surface onto which the food is to be printed. The control unit can be configured to control the lifting motor for the printing of a food (e.g. as a function of a recipe). Changing the height of the printing head enables even complex structures of foods (in particular foods with a relatively large spread in their height) to be printed in a precise manner.

The positioning means can comprise a movable printing arm, which is configured to move the printing head in parallel to the printing surface onto which the food is to be printed. In this case the printing arm can comprise at least three joints with assigned joint motors, which connect the printing head to a connecting element fixed in relation to movements parallel to the printing surface via a number of connecting segments. The control unit can be configured to control the joint motors for the printing of a food (e.g. as a function of a recipe). The use of a printing arm and in particular of a printing arm with at least three joints makes it possible to move to all points on a printing surface in a precise manner. In this way complex structures of foods can be printed. Moreover in this way an available printing surface (e.g. a baking sheet) is able to be used as completely as possible.

The arm segments can comprise a first arm segment and a second arm segment, which are connected directly to one another via a first joint. The first arm segment and the second arm segment can be designed in this case such that, when the first arm segment and the second arm segment are moved towards each other via the first joint, the first arm segment at least partly surrounds the second arm segment on two surfaces. The arm segments can thus engage within one another. This has the effect that the structure of the printing arm restricts a height movement (perpendicular to the printing surface) of the printing arm as little as possible. The described structure of the printing arm thus makes possible a movement of the printing head that is as flexible as possible.

The printing head can comprise an energy source, especially a laser (e.g. a fiber laser), which is configured to heat up a point of the printed food. The control unit can be configured to control the energy source (e.g. as a function of a recipe) in order to cook the food at least partly. The part cooking of printing mass in such cases makes it possible to print complex structures, since printing mass can be solidified by the part cooking (especially by the part baking).

The printing head can include a proximity sensor, which is configured to detect distance information in relation to a distance between the printing head and the printing surface on which the food is to be printed. Furthermore information in relation to the distance between the printing head and the surface of the food can also be detected. The control unit can be configured to control the printing head and/or the positioning means as a function of the distance information. This enables precision for the printing of the food to be enhanced.

In accordance with a further aspect of the invention a further printing unit for the printing of food is described. The printing unit can include any given combination of the features described in this document. In particular the printing unit can comprise a printing head with a nozzle, through which edible printing mass for the printing of a food on a printing surface can be extruded. Moreover the printing unit can comprise printing means, which are configured to move the printing head to different positions above the printing surface. The positioning means can include a movable printing arm, which is configured to move the printing head in parallel to the printing surface on which the food is to be printed. The printing arm in this case can especially include at least three joints with assigned joint motors, which connect the printing head to a connecting element fixed in relation to movements parallel to the printing surface via a number of arm segments. Moreover the printing unit can include a control unit, which is configured to control the positioning means and the nozzle head, in order to push a food out of the nozzle head by means of the printing mass.

The use of a printing arm, and in particular of a printing arm with at least three joints, makes it possible for all points on a printing surface to be able to be moved to in a precise manner by means of the printing head. In this way complex structures of foods can be printed. Moreover the available printing surface (e.g. a baking sheet) can be used as completely as possible in this way.

In accordance with a further aspect of the invention a built-in appliance for building into a kitchen furniture unit is described. The built-in appliance comprises a cooking compartment (e.g. a compartment of an oven) for cooking (e.g. for baking) a food. Furthermore the built-in appliance comprises a flap, via which a food can be taken out of the cooking compartment. Furthermore the built-in appliance comprises a printing unit, which is arranged in the cooking compartment and which is configured to print a food in the cooking compartment. The integration of a printing unit into a built-in appliance enables space to be saved on a working surface of a kitchen. Moreover in this way a number of process steps for producing a food (in particular the printing and the cooking) can be combined, so that the production of a food will be simplified.

The built-in appliance can be configured to accommodate a removable printing surface, in particular a metal sheet, in the cooking compartment. The printing surface can in this case be introduced into the cooking compartment or taken out of the cooking compartment when the flap is open. The printing unit can be configured to print a food directly onto the removable printing surface. In this way the production of a food can be further simplified.

The printing unit installed in a built-in appliance can have any given combination of the features described in this document. In particular the printing unit can be used with a printing arm, so that the different positions in the cooking compartment can be moved to in a flexible way. As an alternative or in addition, a printing unit with a cartridge carrier can be used, which makes it possible to print with different printing masses. In such cases cartridge carriers can preferably be arranged such that the cartridge carrier is accessible via a front side of the built-in appliance (e.g. at or via the flap), so that cartridges can be inserted into the cartridge carrier and removed from it again in a convenient way (especially without having to reach into the interior of the cooking compartment). As an alternative or in addition the printing unit can be used with an energy source in order to make possible a combined local cooking (by the energy source) and global cooking (by the cooking compartment) of food. This enables complex and innovative foods to be produced.

It is to be noted that the devices (especially printing units) and systems (especially built-in appliances) described in this document can be used both on their own and in combination with other devices and systems described in this document. Furthermore any given aspects of the devices and systems described in this document can be combined with one another in a diversity of ways. In particular the features of the claims can be combined with one another in a diversity of ways.

The invention will be described in greater detail below with reference to exemplary embodiments shown in the figures of the enclosed drawing. In the figures:

FIG. 1 shows a block diagram of an example of a system for producing a food;

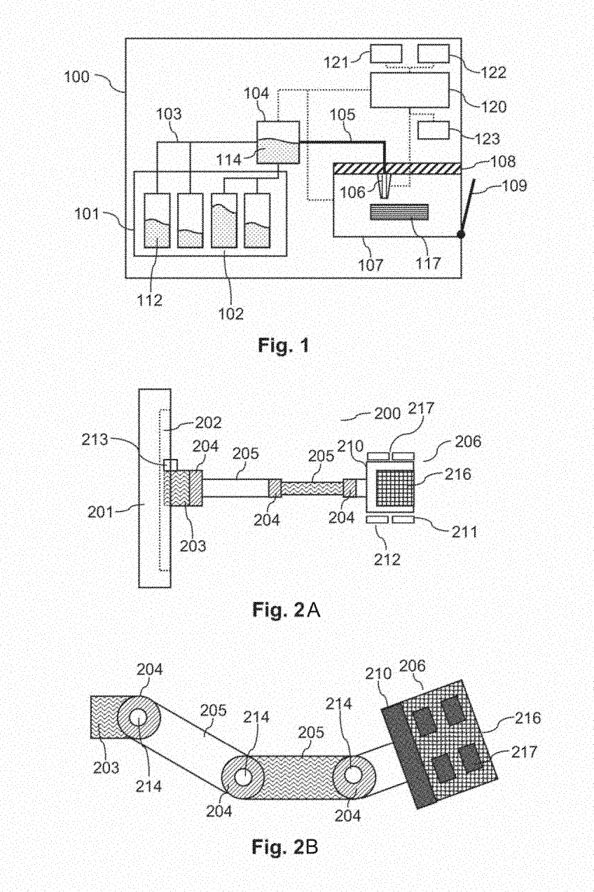

FIG. 2a shows an example of a printing unit in a side view;

FIG. 2b shows an example of a printing unit in an overhead view;

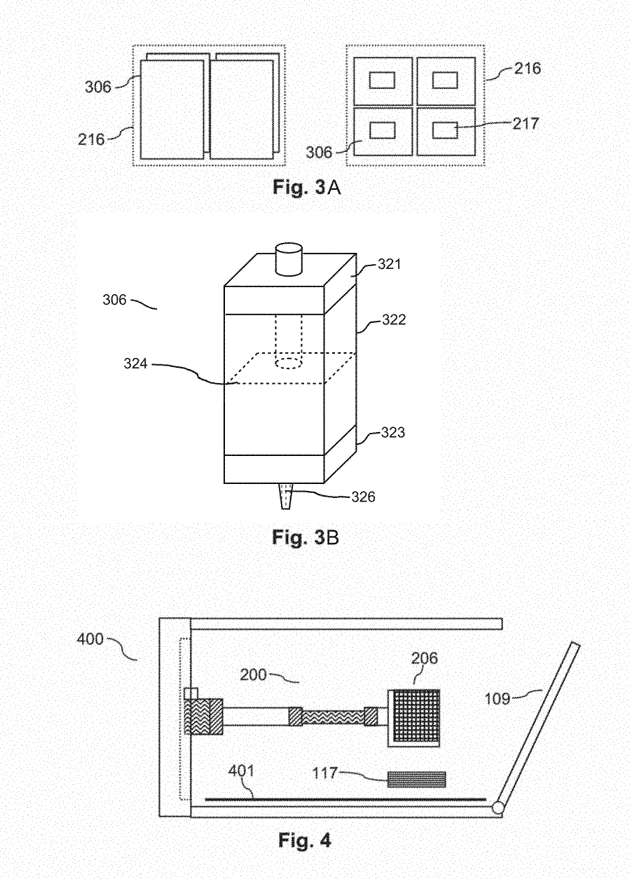

FIG. 3a shows an example of a cartridge carrier;

FIG. 3b shows an example of a cartridge, and

FIG. 4 shows an example of a built-in appliance with a printing unit.

As explained at the start, the present document deals with the flexible and efficient printing of food.

FIG. 1 shows a block diagram of an example of a system 100 for producing a food 117 (e.g. for producing baked goods). The system 100 can comprise one or more containers 102 for accepting a corresponding number of ingredients 112. The one or more containers 102 can be introduced into the system 100 (at positions intended for them) and the containers 102 can be exchanged if necessary. For example the containers 102 can comprise a capsule or a cartridge. The one or more containers 102 can be arranged within the system 100 in a temperature-control unit 101 (e.g. in a refrigerator). Controlling the temperature of the one or more containers 102 enables the storage life of the ingredients 112 contained therein to be extended.

The edible ingredients 112 can, at least in part, have a moldable consistency. The edible ingredients 112 can be present at least in part in puréed form and/or as a moldable dough for example. Furthermore the ingredients 112 can comprise different components of a food 117 to be created. For example the ingredients 112 in a first container 102 can comprise a dough for a baked item. A second container 102 can e.g. contain a fruit component and a third container 102 can e.g. contain a chocolate component. In addition sugar can be provided as an ingredient 112 in one of the containers 102. In this way different variants of a baked item can be produced by the system 100 (e.g. with different sugar content, with or without a chocolate flavor, with or without fruit flavor, etc.).

The one or more containers 102 can be connected via lines 103 to a mixing unit 104 and/or be connected directly to a nozzle 106. In the mixing unit 104 one or more of the ingredients 112 from the one or more containers 102 can be mixed, in order to create a printing mass 114 for the production of the food 117. As an alternative or in addition, printing mass 114 can be provided directly for the printing from the one or more containers 120. The printing mass 114 can be conveyed via a line 105 to a nozzle 106, wherein the nozzle 106 is configured to eject or to expel the printing mass 114 at specific positions, in order to create a spatial arrangement of printing mass. For example different printing masses 114 can be ejected in layers, in order to create a spatial arrangement layer-by-layer from the different printing masses 114. The nozzle 106 can be arranged movably on a rail 108 for this purpose, so that the nozzle 106 can be moved to different positions, and can eject printing mass 114 at different positions.

The spatial arrangement produced on the basis of the printing mass 114 can be cooked in its entirety by a cooking unit 107, in order to create a ready-cooked (e.g. a baked) food 117. The cooking unit 107 can comprise a thermal oven, a microwave oven, a steamer unit, a grill and/or a pan. In the example shown in FIG. 1 the spatial arrangement of printing mass 114 is ‘printed’ directly by the nozzle 106 within the cooking unit 107. This is advantageous since in this way the effort for transporting the spatial arrangement to the cooking unit 107 can be reduced.

The ready-cooked food 117 can be output to a user via an output 109 of the system 100. In the example shown the cooking unit 107 comprises a flap 109 through which the user can take the food 117 out of the cooking unit 107 (i.e. out of the cooking compartment).

The system 100 comprises a control unit 120, which is configured to establish a recipe for a food 117 to be created. To do this for example, the control unit 120 can refer back to a recipe database on a memory unit 123 of the system 100. As an alternative or in addition, the control unit 120 can access an external recipe database via a communication unit 121. The communication unit 121 can be configured to communicate with an external server via a wired or wireless communication link. As an alternative or in addition, the recipe can be provided or selected via a user interface 122 (e.g. via a touch-sensitive screen of the system 100) for the control unit 120.

The control unit 120 is further configured, as a function of the recipe, to apply specific quantities of ingredients 112 or printing mass 114 from the containers 102 (if necessary via the mixing unit 104) to the spatial arrangement of printing mass 114 or to the food 117 to be produced. Furthermore the control unit 120 can be configured to control the cooking unit 107 of the system 100 as a function of the recipe, in order to cook the spatial arrangement of printing mass 114 at least partly.

As already explained above it can be desirable, for the creation of a food 117, to apply different printing masses 114 at different points to the food 117 in a flexible manner. This is only possible to a limited extent with the system 100 shown in FIG. 1. In particular different printing masses 114 can only be applied to the food 117 under some conditions via the nozzle 106. Furthermore the nozzle 106 can also only be positioned via a rail 108 in a restricted way above the food 117. Therefore a printing unit will be described below through which the flexibility for the printing of foods 117 can be increased. The printing unit can be controlled by the control unit 120 described above. Furthermore the above-mentioned user interface 122 can be used for the printing unit.

FIG. 2a shows a side view of an example of a printing unit 200, which can be used if necessary in a food printer such as the system 100 for example, in order to extrude printing mass 114 in a flexible manner at different points. The printing unit 200 comprises a linear lift (also referred to as a lifting means) 201, 202, 213, with which the height of a printing arm 203, 204, 205 and of a printing head 206 of the printing unit 200 can be adjusted. In particular a connecting element 203 of the printing arm 203, 204, 205 can be moved up and down along a rail 202 of the linear lift 210, 202, 213. A lifting motor 213 can be activated for this purpose.

The printing arm 203, 204, 205 comprises three joints 204 with which the connecting element 203 of the printing arm, individual arm segments 205 of the printing arm and the printing head 206 can be turned in relation to one another. The joints 204 can be adjusted by joint motors 214 (see FIG. 2b, which shows the printing unit 200 in a view from above). The adjustment of the joints 204 enables the printing head 206 to be positioned at different points in a flexible manner.

The printing head 206 is fastened to the front side of the printing arm 203, 204, 205. The printing arm 203, 204, 205 in its turn is connected via the connecting element 203 to the lifting means 201, 202, 213, which are responsible for the up and down movements of the printing head 206. A hybrid stepping motor 214 with microstepping can be built into each joint 204 of the printing arm 203, 204, 205. In this way small increments are made possible. The connection of the arm segments 205 via three articulation points 204 makes the printing arm 203, 204, 205 flexible and thus enables it to reach all points on a specific printing surface. Cables for the activation and supply of energy to the joint motors 214 and/or the printing head 206 can be routed through hollow arm segments 205.

The printing head 206 comprises a printing-head body 210, which is connected rigidly to the printing arm 203, 204, 205. A carrier 216 for one or more cartridges with printing mass 114 can be mounted on the printing-head body 210. The cartridge carrier 216 can be taken off by a user, in order to insert one or more cartridges with specific printing masses 114. Information in relation to the cartridges that must be inserted into the cartridge carrier 216 can be displayed via the user interface 122.

The printing head 206 (in particular the printing-head body 210) can include a laser 212 (e.g. a fiber laser), in order to make an integrated cooking process possible. Furthermore the printing head 206 (in particular the printing-head body 210) can include a proximity sensor 211, with which the printing head 206 can be calibrated to a specific printing surface (e.g. to a baking sheet) for the food 117. In the upper area of the printing head 206 (in particular the printing-head body 210) one or more (e.g. four) telescopic lifting motors 217 (referred to in this document as cartridge motors) can be arranged, with which the cartridges can be printed during the printing process.

FIG. 3a shows an example of a cartridge carrier 216 in a view from the side (on the left) and from above (on the right). The cartridge carrier 216 can be configured to accept one or more cartridges 306 for printing mass 114. For example the cartridge carrier 216, as shown in FIG. 3a, can accept four small cartridges 306 (also referred to as first cartridges). The printing head 206 includes a cartridge motor 217 for each of the first cartridges 306, with which the printing mass 114 can be pushed out of a respective first cartridge 306. As an alternative the carrier 216 can accept one or more medium cartridges 306 (also referred to in this document as second cartridges), which are the size of two small cartridges 306. As an alternative the carrier 216 can accept one large cartridge 306 (also referred to in this document as a third cartridge), which is the size of four small cartridges 306.

FIG. 3b shows an example of a structure of a cartridge 306. The cartridge 306 has a cartridge lid 321, a (hollow) cartridge body 322 and a cartridge bottom 323 with integrated cartridge nozzle 326. The cartridge lid 321 can have an integrated plunger 324 or the cartridge lid 321 can itself be used as the plunger 324. The printing mass 114 for the food 117 can be accommodated in the interior of the cartridge body 322. Via the cartridge lid 321, by means of a cartridge motor 217, the plunger 324 (i.e. if necessary the cartridge lid 321 itself), can be pushed into the interior of the cartridge body 322, in order to extrude the printing mass 114 via the cartridge nozzle 326.

The division of the cartridge 306 into lid 321, body 322 and bottom 323 enables a cartridge 306 to be cleaned efficiently. After a printing process the cartridges 306 can be taken out of the printing head 206, broken down into individual parts and in this way be fully cleaned. Furthermore the structure described avoids the printing head 206 itself becoming contaminated. Only the cartridges 306 come into contact with the foods, since the plunger 324 and the nozzle 326 are already integrated into the respective cartridge 306.

As explained above, cartridges 306 with different capacities can be provided, e.g. for a large cartridge, appr. 265 ml of printing mass 114, for a medium cartridge, appr. 130 ml of printing mass 114 and for a small cartridge, appr. 65 ml of printing mass 114. Typically for the production of a food 117 (e.g. of baked goods on a baking sheet) approximately 180 ml of printing mass 114 is sufficient. Cartridge bottoms 326 with different nozzle sizes enable the printing strength to be varied.

Four telescopic lifting motors 217 are located in the upper area of the printing head 206 for example. These cartridge motors 217 insure that the cartridges 306 will be printed. A driven telescopic bar or cylinder in this case pushes the plunger 324 of a cartridge 306 downwards. The motors 217 are placed so that with each combination of cartridges 306 with different sizes, an even printing out of the printing mass 114 is guaranteed.

A laser 212 arranged on the printing head 306 can be used to bake extruded printing mass 114 layer-by-layer. It thus becomes possible also to produce more complex forms for a food 117. The exit of the laser beam is located typically on the underside of the printing head 206, directly behind the nozzles 326 of the inserted cartridges 306. A proximity sensor 211 can be arranged next to the laser 212. The proximity sensor 211 can be used to calibrate the printing head 206 before the printing process to the right height of the surface to be printed.

The printing unit 200 can be provided within the framework of a built-in appliance 400 (e.g. within the framework of a built-in oven). This is shown by way of example in FIG. 4. By means of the printing arm of the printing unit 200 the printing head 206 can be positioned at different points above the printing surface 401 for a food 117 (e.g. above a baking sheet). Furthermore a cooking process (especially a baking process) can be carried out directly within the built-in unit 400.

Building it into the built-in appliance 400 allows the printing unit 200 to be integrated seamlessly into the kitchen environment and it can be combined if necessary with a baking oven. Thus no space is needed on the work surface of a kitchen. The built-in appliance 400 can be inserted into a cabinet and fixed at the sides. The screws can subsequently be covered by placing cap covers over them.

The printing unit 200 described makes it possible to print simultaneously with up to four different printing masses 114. Through this the printing process is optimized and filled baked goods, decoration articles or snacks can also be produced for example.

The process of using the printing unit 200 can be optimized by an integrated baking process. With the aid of a laser 212 the food 117 is allowed to be (at least partly) baked directly. The laser 212 can be positioned exactly and thus only bake partly at the desired points. Fillings can remain untouched for example. Through this process it is also possible to achieve different degrees of baking in one food 117. Thus intermediate layers that are crispy can be produced in one food 117 for example. The structure of the printing head 206 described means that the appliance 400 is easy to clean. Only the material containers or cartridges 306 become contaminated. The multi-part construction of the material containers or cartridges 306 makes them easy to clean.

An enhanced operating convenience can also be provided in the interior of the appliance 400. An integrated fully slide-out shelf enables the printing surface 401 to be easily removed. The surface to be printed 401 can be the size of a baking sheet for example. The surface to be printed 401 can be inserted into the appliance 400. To monitor the cooking process interior lighting can be provided in the appliance 400.

Furthermore the appliance 400 can have a user interface 122 (e.g. a touch-sensitive screen), with which the appliance 400 and especially the printing unit 200 can be controlled. Furthermore feedback about a printing process can be output via the user interface 122. In particular the operation and control of the appliance 400 in all steps (start/stop of the appliance, recipe selection and recipe search, creation of forms, selection of a desired form, number of foods 117 etc.) can be undertaken at the appliance 400 itself via the user interface 122.

The choice of a built-in appliance 400 and the use of a baking sheet that this makes possible make a large area to be printed possible. By choosing sufficiently large cartridges 306 it is possible to print the entire printable surface with dough creations. An integrated full extraction in combination with a hinged-down door or flap 109 allow a baking sheet 401 to be pulled out of the appliance 400 and removed from it in the optimum way. The way in which the printing head 206 functions makes a fast printing process possible. Through its integrated baking process, the appliance 400 shown in FIG. 4 possesses the advantage that the working steps “forming” and “setting” are combined in one appliance 400.

Through the described printing unit 200 it is possible, in a specific space (e.g. in an oven) to print printing mass 114 on the entire surface. The option of moving the printing unit 200 upwards and downwards makes it possible to place a baking sheet as the printing platform in the interior of an appliance 400 and to support this for easier use on fully slide-out shelves. Through the construction of the cartridges 306 and through its positioning in the printing head 206, the printing unit 200 is easy to clean. In this case the printing unit 200 itself does not come into contact with the printing masses 114 used.

The cartridge body 322 can be a material (e.g. stainless steel) that can be cooled in advance and can subsequently emit the stored cold to the printing mass 114, in order to cool the printing mass 114 during the printing process.

The use of a laser 212 enables the printing and the baking process to be combined with one another. In this way complex structures can be created, since extruded printing mass 114 can be part baked (e.g. at specific places). Other places on the other hand can remain unaffected by the laser heat.

The present invention is not restricted to the exemplary embodiments shown. In particular it should be noted that the description and the figures are only intended to illustrate the principle of the proposed devices and systems.

1-15. (canceled)

16. A printing unit for printing food, the printing unit comprising:
a printing head to be positioned above a printing surface for an item of food to be printed, said printing head having a printing-head body and a cartridge carrier;
a cartridge having a plunger, a cartridge body and a cartridge bottom with a cartridge nozzle;
said cartridge carrier being configured to accept at least one removable said cartridge for edible printing mass in a position in which said plunger is arranged on top and said cartridge nozzle is arranged at the bottom; and
said printing-head body including a cartridge motor configured to push said plunger of said cartridge inserted in said cartridge carrier from above downward in order to push the printing mass via said cartridge nozzle out of the cartridge and onto the printing surface;
a positioning device configured to move said printing head to different positions above the printing surface; and
a control unit configured to control said positioning device and said cartridge motor in order to print an item of food with the printing mass from the inserted cartridge.

17. The printing unit according to claim 16, wherein:
the printing unit comprises a cartridge accommodated in said cartridge carrier; and
said plunger, said cartridge body and a cartridge bottom are configured to be separated from one another by a user for cleaning.

18. The printing unit according to claim 16, wherein
said cartridge carrier is configured to removably accept a plurality of said cartridges; and
said printing-head body has at least one cartridge motor for each of said plurality of said cartridges.

19. The printing unit according to claim 18, wherein said cartridge carrier is configured to accept cartridges with different capacities for printing mass.

20. The printing unit according to claim 19, wherein said cartridge carrier is configured:
to accept at least two first cartridges with a first capacity; and
to accept a second cartridge with a second capacity that is greater than the first capacity in a space for two first cartridges; and/or
to accept a third cartridge with a third capacity that is greater than the second capacity in a space for two second cartridges.

21. The printing unit according to claim 20, wherein:
said cartridge carrier is configured to accept at least the following combinations of cartridges:
four first cartridges;
two second cartridges;
two first cartridges in combination with a second cartridge;
a third cartridge;
said printing-head body has a cartridge motor for each of the four first cartridges;
said plunger of a second cartridge is actuated by two cartridge motors; and
said plunger of a third cartridge is actuated by four cartridge motors.

22. The printing unit according to claim 16, wherein:
said positioning device comprises a lifting device with a lifting motor configured to change a height of said printing head relative to the printing surface; and
said control unit is configured to control said lifting motor for printing the item of food.

23. The printing unit according to claim 22, wherein said positioning device comprises a movable printing arm configured to move said printing head parallel with the printing surface.

24. The printing unit according to claim 23, wherein:
said printing arm is formed with at least three joints with respectively assigned joint motors, the joints connecting said printing head to a connecting element that is fixed in relation to movements parallel with the printing surface via a plurality of arm segments; and
said control unit is configured to control said joint motors for printing the item of food.

25. The printing unit according to claim 24, wherein:
said arm segments include a first arm segment and a second arm segment that are connected to one another directly via a first joint; and
said first arm segment and said second arm segment are configured such that, when said first arm segment and said second arm segment are moved towards each other via said first joint, said first arm segment at least partly surrounds said second arm segment on two surfaces.

26. The printing unit according to claim 16, wherein:
said printing head comprises an energy source configured to heat up a region of the item of food; and
said control unit is configured to control said energy source in order to cook the item of food at least partially.

27. The printing unit according to claim 26, wherein said energy source is a laser.

28. The printing unit according to claim 16, wherein:
said printing head comprises a proximity sensor configured to determine distance information in relation to a distance between said printing head and the printing surface; and
said control unit is configured to control one or both of said printing head and said positioning device based on the distance information.

29. A printing unit for printing food, the printing unit comprising:
a printing head with a nozzle to be positioned above a printing surface for an item of food to be printed, wherein an edible printing mass for printing the item of food can be extruded through said nozzle onto the printing surface;
a positioning device configured to move said printing head to different positions above the printing surface;
said positioning device including a movable printing arm configured to move said printing head parallel to the printing surface;
said printing arm having at least three joints with assigned joint motors that connect said printing head to a connecting element fixed in relation to movements parallel with the printing surface via a number of arm segments; and
a control unit configured to control said positioning device and said printing head, in order to print a food with the printing mass ejecting from said nozzle of said printing head.

30. A built-in appliance for building into a kitchen furniture unit, the built-in appliance comprising:
a cooking compartment for cooking a food;
a flap enabling an item of food to be taken out of said cooking compartment; and
a printing unit according to claim 16 disposed in said cooking compartment and configured to print the item of food in said cooking compartment.

31. The built-in appliance according to claim 30, wherein:
said cooking compartment is formed to accommodate a removable printing surface;
said printing surface, when the flap is open, is insertible into said cooking compartment and removable from the cooking compartment; and
said printing unit is configured to print the item of food directly onto said removable printing surface.

32. The built-in appliance according to claim 31, wherein said printing surface is a metal sheet.
